(19) United States
(12) Patent Application Publication
(10) Pub. No.: US 2006/0033043 A1
(43) Pub. Date: Feb. 16, 2006

(54) Stacked six degree-of-freedom table

(75) Inventor: Yoichi Arai, Belmont, CA (US)

Correspondence Address: BEYER WEAVER & THOMAS LLP, P.O. BOX 70250, OAKLAND, CA, 94612-0250, US

(73) Assignee: Nikon Corporation, Tokyo (JP)

(21) Appl. No.: 10/918,584

(22) Filed: Aug. 13, 2004

(51) Int. Cl. G03B 9/20

(52) U.S. Cl. 250/492.2; 250/442.11; 355/72

(57) ABSTRACT

A table with six degrees of freedom, such as a wafer table for a lithography system, has an upper table stacked on top of a lower table. Each of these two stacked tables has three degrees of freedom and is provided with actuators for controlling its motions in these three degrees of freedom. The vertical motion, the pitching and the rolling of the lower table may be controlled by actuators that may be voice coil motors. The upper table is supported on the flat top surface of the lower table so as to be slidable laterally, or two dimensionally. This two dimensional motion of the upper table and its yaw may be controlled by another set of actuators which may be smaller voice coil motors. A wafer holder supporting a workpiece such as a wafer for the lithography system may be secured onto the upper table by a vacuum suction mechanism.

### BACKGROUND OF THE INVENTION

This invention is in the technical field of controlling the six degrees of freedom of a rigid body such as a wafer table.

It has been known, for example, to support a workpiece, such as a wafer on which an image is to be projected in a lithographic projection system, on a table and to directly control its six degrees of freedom of motion, say, by means of motors. It is difficult, however, to control all six degrees of freedom of motion of such a table directly because each control mechanism for a degree of freedom must effect its control at a portion of the table which is also being controlled by the other control mechanisms for the other degrees of freedom.

### SUMMARY OF THE INVENTION

It is therefore an object of this invention to provide a more easily controllable wafer table device with six degrees of freedom.

It is another object of the invention to provide a lithography system incorporating a wafer holder supported by such an improved wafer table device.

A table device with six degrees of freedom, embodying this invention, such as a wafer table for a lithography system, may be characterized in most simple terms as having two tables stacked one on top of the other, each having three degrees of freedom and being provided with actuating devices for controlling motions in these three degrees of freedom. The vertical motion, the pitching and the rolling of the lower table may be controlled by actuating devices that may comprise voice coil motors. The upper table is supported on the flat top surface of the lower table so as to be slidable laterally, or two dimensionally. This two dimensional motion of the upper table and its yaw may be controlled by another set of actuating devices which may be smaller voice coil motors. A wafer holder supporting a workpiece such as a wafer for a lithography system may be adapted to be secured onto the upper table by a vacuum suction mechanism. In this manner, the six degrees of freedom of motion of the workpiece can be more easily controlled by adjusting two tables each having three degrees of freedom of motion.

According to a preferred embodiment of the invention, the wafer holder and the lower table are each provided with a pair of integrally formed mirrors having mutually *perpendicular reflecting surfaces. An interferometer may be used to project beams of light on these mirrors to detect the relative positions and orientations of the lower table and the wafer holder such that the required number of encoders conventionally required for such detections can be reduced and hence the table can be made lighter and the number of cables leading to the table can also be reduced.

A lithography system of this invention is characterized as using a wafer table device as characterized above. The invention also relates to a method of lithography characterized as using a system embodying this invention and products obtained by such a production method.

### BRIEF DESCRIPTION OF THE DRAWING

The invention, together with further objects and advantages thereof, may best be understood with reference to the following description taken in conjunction with the accompanying drawings in which:

FIG. 1 is a cross-sectional schematic view of a lithographic exposure apparatus incorporating wafer-supporting table of this invention;

FIG. 2 is a process flow diagram illustrating an exemplary process by which semiconductor devices are fabricated by using the apparatus shown in FIG. 1 according to the present invention;

FIG. 3 is a flowchart of the wafer processing step shown in FIG. 2 in the case of fabricating semiconductor devices according to the present invention;

FIG. 4 is a diagonal external view of a wafer-supporting table embodying this invention;

FIG. 5 is a side view of the table of FIG. 4;

FIG. 6 is an exploded diagonal view of the table of FIGS. 3 and 4; and

FIG. 7 is a diagonal view of the upper table.

### DETAILED DESCRIPTION OF THE INVENTION

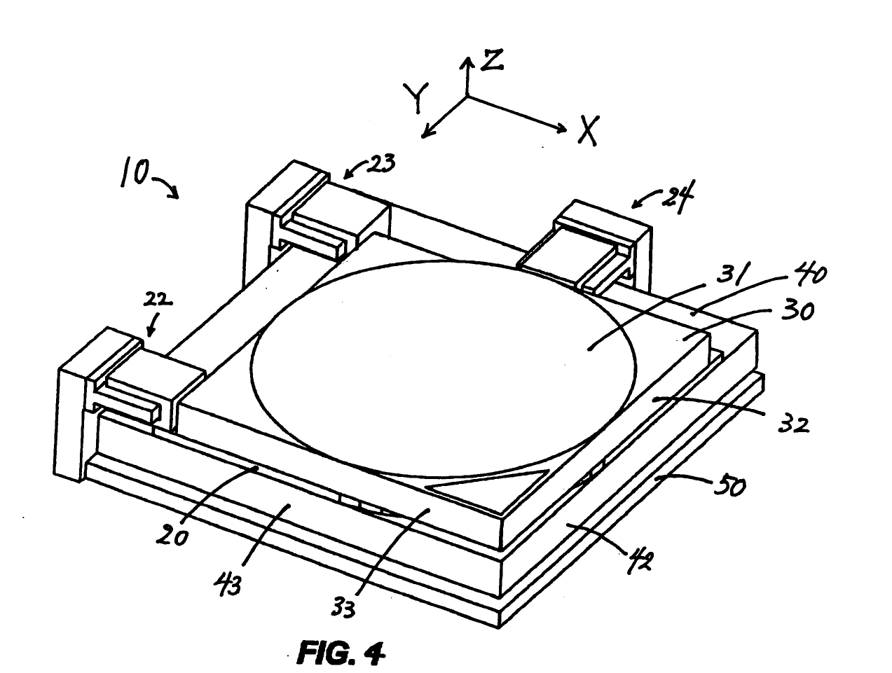

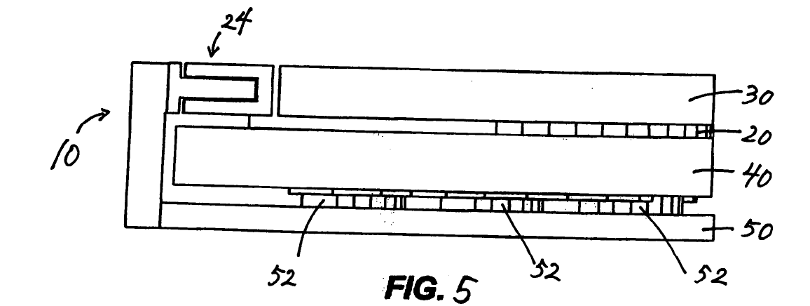

As shown in FIGS. 4, 5 and 6, a table 10 according to this invention may be characterized in most basic terms as comprising two mutually independently position-controllable plates (tables) stacked one on top of the other, or an upper table 20 which supports a wafer holder 30 directly on top thereof and a lower table 40 which supports the upper table 20 on its top surface such that the upper table 20 and the lower table 40 together form a stacked structure. The lower table 40 is placed above a base plate 50. The upper table 20 is made slidable in a two-dimensional plane over the upper surface of the lower table 40 by means of an air bearing, to be explained more in detail below.

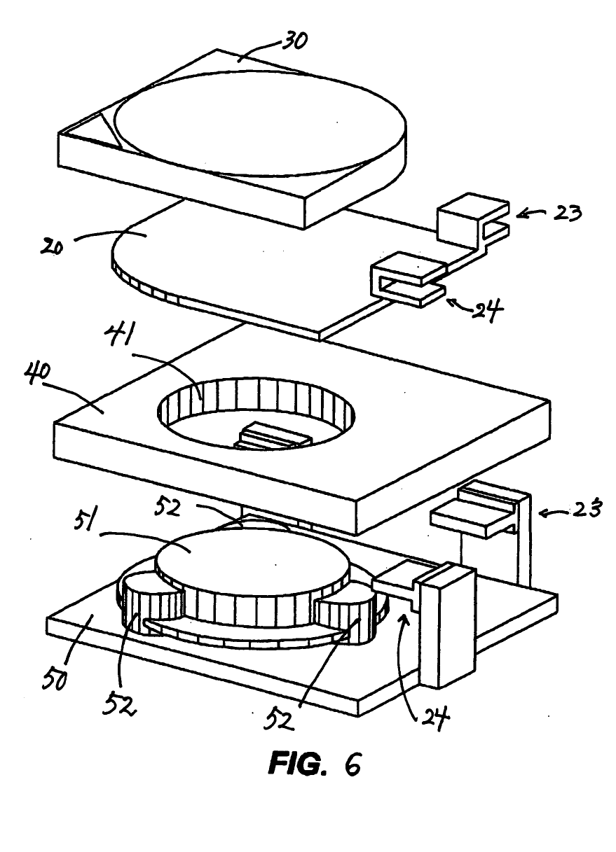

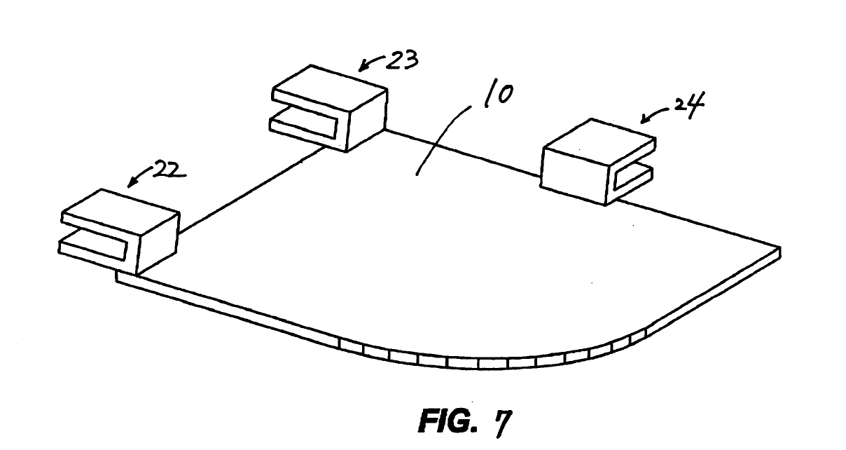

The two-dimensional lateral motion of the upper table 20 over the upper surface of the lower table 40 is controlled by means of three voice coil motors (VCMs), including two X-VCMs 22 and 23 for controlling the motion in the direction of the X-axis and the yaw (or the motion around the Z-axis) and one Y-VCM 24 for controlling the motion in the direction of the Y-axis. The magnet parts of these VCMs are attached to the upper table 20 and their coil parts are attached to the base plate 50, as shown in FIGS. 6 and 7.

The lower table 40 is formed with a circular throughhole 41, as shown in FIG. 6, and the base plate 50 supports a circular cylindrically shaped leveling table 51, as shown in FIG. 6. The cylindrically shaped portion of the leveling table 51 engages the circular throughhole 41 of the lower table 40 such that the leveling table 51 and the lower table 40 are securely attached to each other so as to move together, controlled by three cylinder-type leveling VCMs 52. These three cylinder-type VCMs 52 are distributed at mutually equal distances peripherally around the Z-direction. In other words, these three leveling VCMs 52 control the motion of the leveling table 51, and hence also of the lower table 40 in the direction of the Z-axis, as well as their pitch and roll (or the motions around the X-axis and the Y-axis). The aforementioned air bearing may be provided at the top surface of the leveling table 51.

In summary, the three leveling VCMs 52 serve to control the position and orientation of the lower table 40 in three of the six degrees of solid-body freedom of motion and the X-VCMs 22 and 23 and the Y-VCM 24 control the position and orientation of the upper table 20 in the remaining three degrees of freedom, while the upper table 20 is supported by the lower table 40 and hence all six of its six degrees of freedom are controlled but not all directly but through the two mutually independently controlled tables 20 and 40.

As shown in FIG. 4, the wafer holder 30 has not only a chuck 31 on its upper surface for supporting a wafer (not shown), but mirrors (a front-surface mirror 32 and a side-surface mirror 33) are integrally attached to its mutually perpendicular horizontally extending outer surfaces perpendicular respectively to the X-axis and the Y-axis. Similarly, the lower table 40 has two mirrors (a front-surface mirror 42 and a side-surface mirror 43) integrally attached to its mutually perpendicular horizontally extending outer surfaces perpendicular respectively to the X-axis and the Y-axis. These integrally attached mirrors 32, 33, 42 and 43 are for detecting the positions and the orientations of the wafer holder 30 and the lower table 40 with the help of an interferometer (not shown).

To explain more in detail, light beams from the interferometer may be made incident perpendicularly at least at two places on the front-surface mirror 42 of the lower table 40 and at least at one place on the side-surface 43. By analyzing the reflected beams, the interferometer can detect the X-coordinate, the Y-coordinate and the yawing position (angular position around the Z-axis) of the lower table 40. Similarly, a plurality of light beams from the interferometer made incident perpendicularly to the front-surface and side-surface mirrors 32 and 33 of the wafer holder 30 and reflected back to the interferometer may be analyzed to detect the X- and Y-coordinates and the yawing, pitching and rolling positions (in five degrees of freedom) of the wafer holder 30. Thus, encoders are not required for the lateral displacements. Only three encoders are required to detect the relative position and orientation between the wafer holder 30 and the lower table 40. This method of detecting the position and orientation of the wafer holder 30, and hence the wafer which is held therein, is advantageous over the prior art method which required six encoders because the number of cables to the encoders as well as the total weight of the table structure can be reduced.

Although a wafer table of the invention has been described above by way of only one example and in terms only of a few of its features, they are not intended to limit the scope of the invention. Many modifications and variations are possible and some additional considerations may be included in what has been specifically disclosed. For example, a vacuum suction system may be incorporated for removably positioning the wafer holder 30 on the top surface of the upper table 20 such that they move together while the vacuum suction system is in operation but the wafer holder 30 can be removable from the top surface of the upper table 20, say, for cleaning. A cooling system using water as its cooling liquid may also be incorporated for cooling the coil parts of the VCMs 22, 23, 24 and 52. For controllably changing the positions and orientations of the tables 20 and 40, actuators other than VCMs may be used instead. In summary, the description above is intended to be interpreted broadly and all such modifications and variations that may be obvious to a person skilled in the art are intended to be included within the scope of the invention.

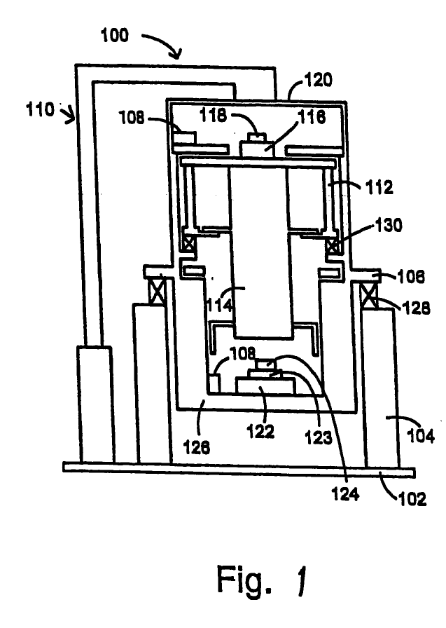

FIG. 1 shows a typical lithographic exposure apparatus 100 incorporating the wafer table of this invention, comprising a mounting base 102, a support frame 104, a base frame 106, a measurement system 108, a control system (not shown), an illumination system 110, an optical frame 112, an optical device 114, a reticle stage 116 for retaining a reticle 118, an upper enclosure 120 surrounding the reticle stage 116, a wafer stage 122, a wafer table 123 (which may be as described above and shown at 10) for retaining a semiconductor wafer workpiece 124 (which may be supported in a wafer holder such as described above and shown at 30), and a lower enclosure 126 surrounding the wafer stage 122.

The support frame 104 typically supports the base frame 106 above the mounting base 102 through a base vibration isolation system 128. The base frame 106 in turn supports, through an optical vibration isolation system 130, the optical frame 112, the measurement system 108, the reticle stage 116, the upper enclosure 120, the optical device 114, the wafer stage 122, the wafer table 123 and the lower enclosure 126 above the base frame 106. The optical frame 112 in turn supports the optical device 114 and the reticle stage 116 above the base frame 106 through the optical vibration isolation system 130. As a result, the optical frame 112, the components supported thereby and the base frame 106 are effectively attached in series through the base vibration isolation system 128 and the optical vibration isolation system 130 to the mounting base 102. The vibration isolation systems 128 and 130 are designed to damp and isolate vibrations between components of the exposure apparatus 100 and comprise a vibration damping device. The measurement system 108 monitors the positions of the stages 116 and 122 relative to a reference such as the optical device 114 and outputs position data to the control system. The optical device 114 typically includes a lens assembly that projects and/or focuses the light or beam from the illumination system 110 that passes through the reticle 118. The reticle stage 116 is attached to one or more movers (not shown) directed by the control system to precisely position the reticle 118 relative to the optical device 114. Similarly, the wafer stage 122 includes one or more movers (not shown) to precisely position the wafer workpiece 124 with the wafer table 123 relative to the optical device (lens assembly) 114.

As will be appreciated by those skilled in the art, there are a number of different types of photolithographic devices. For example, exposure apparatus 100 can be used as a scanning type photolithography system, which exposes the pattern from reticle 118 onto wafer 124 with reticle 118, and wafer 124 moving synchronously. In a scanning type lithographic device, reticle 118 is moved perpendicular to an optical axis of optical device 114 by reticle stage 116 and wafer 124 is moved perpendicular to an optical axis of optical device 114 by wafer stage 122. Scanning of reticle 118 and wafer 124 occurs while reticle 118 and wafer 124 are moving synchronously.

Alternatively, exposure apparatus 100 can be a step-and-repeat type photolithography system that exposes reticle 118 while reticle 118 and wafer 124 are stationary. In the step and repeat process, wafer 124 is in a constant position relative to reticle 118 and optical device 114 during the exposure of an individual field. Subsequently, between consecutive exposure steps, wafer 124 is consecutively moved by wafer stage 122 perpendicular to the optical axis of optical device 114 so that the next field of semiconductor wafer 124 is brought into position relative to optical device 114 and reticle 118 for exposure. Following this process, the images on reticle 118 are sequentially exposed onto the fields of wafer 124 so that the next field of semiconductor wafer 124 is brought into position relative to optical device 114 and reticle 118.

However, the use of exposure apparatus 100 provided herein is not limited to a photolithography system for a semiconductor manufacturing. Exposure apparatus 100, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines. The present invention is desirable in machines where it is desirable to prevent the transmission of vibrations.

The illumination source (of illumination system 110) can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to optical device 114, when far ultra-violet rays such as the excimer laser is used, glass materials such as quartz and fluorite that transmit far ultra-violet rays is preferably used. When the F₂ type laser or x-ray is used, optical device 114 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

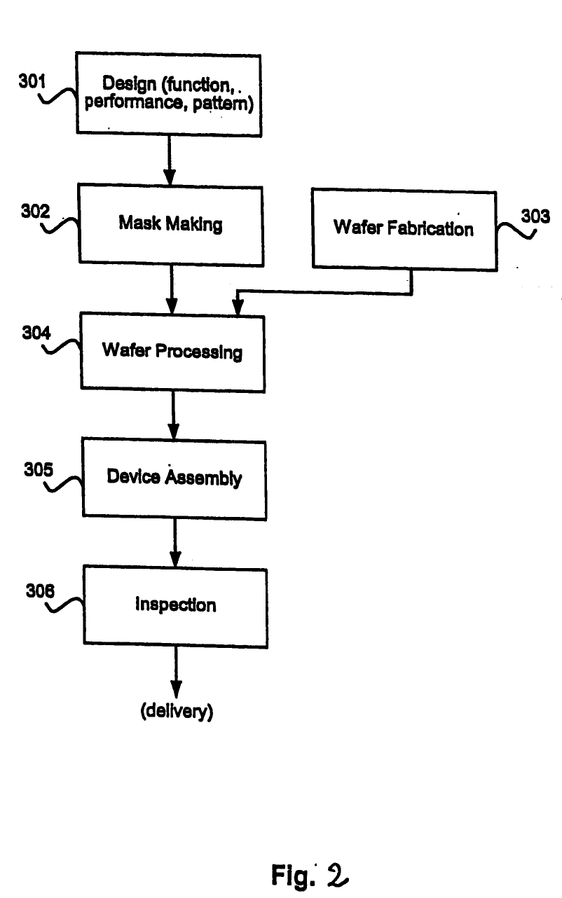

Further, semiconductor devices can be fabricated using the above described systems, by the process shown generally in FIG. 2. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system such as the systems described above. In step 305 the semiconductor device is assembled (including the dicing process, bonding process and packaging process), then finally the device is inspected in step 306.

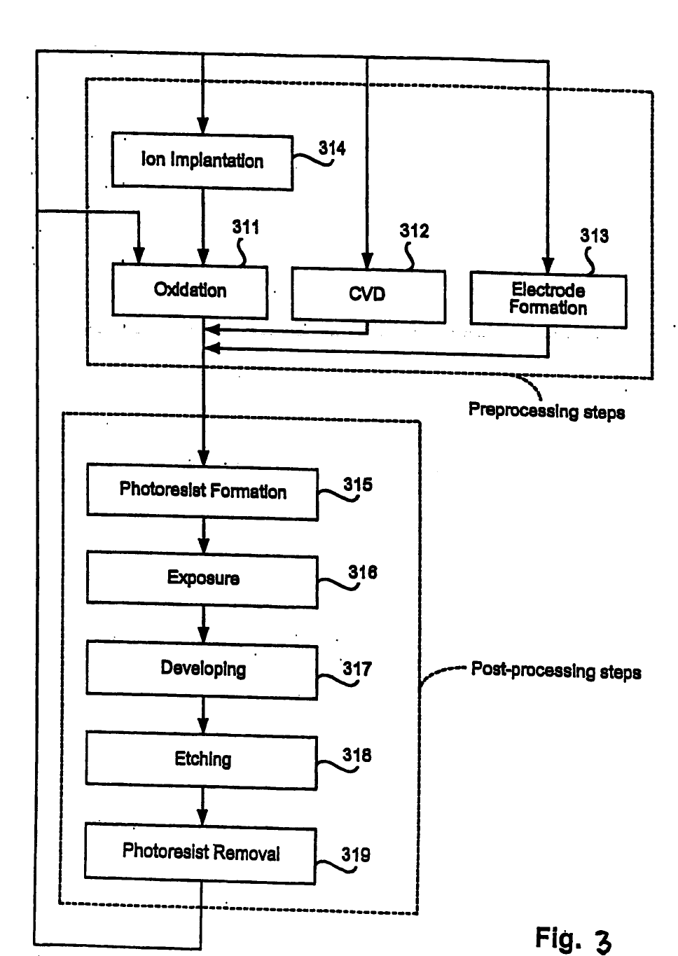

FIG. 3 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

While a lithography apparatus of this invention has been described in terms of only some preferred embodiments, there are alterations, permutations, and various substitute equivalents which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A table device with six degrees of freedom, said table device comprising:
a base plate;
a lower table with a top surface, said lower table being supported above said base plate;
an upper table stacked above said lower table so as to move on and along said top surface;
a lower table actuating device connected to said lower table, said lower table actuating device moving said lower table in three of said six degrees of freedom; and
an upper table actuating device connected to said upper table, said upper table actuating device moving said upper table in the remain in the remaining three of said six degrees of freedom.

2. The table device of claim 1 wherein said upper table actuating device controls motion of said upper table in horizontal directions and the yawing, said lower table actuating device controls motion of said lower table in the vertical direction, the pitching and the rolling.

3. The table device of claim 1 wherein said lower and upper table actuating devices include at least one voice coil motor respectively.

4. The table device of claim 1 further comprising a holder that holds therein a workpiece, said holder being removably connected to said upper table.

5. The table device of claim 4 wherein both said lower table and said holder have a pair of mutually perpendicularly oriented mirrors integrally formed thereon.

6. The table device of claim 1 wherein said lower and upper table actuating devices are partly supported by said base plate.

7. The table device of claim 1 wherein said upper table actuating device comprises a plurality of voice coil motors, said voice coil motors each comprise magnets affixed to said upper table and coils supported by said base plate.

8. The table device of claim 1 further comprising a bearing device disposed between said upper table and said top surface of said lower table.

9. A lithography system that forms a pattern on an object, said lithography system comprising:
an illumination system that irradiates radiant energy; and
a stage device that carries said object disposed on a path of said radiant energy;
wherein said stage device includes a table device with six degrees of freedom, said table device comprising:
a base plate;
a lower table with a top surface, said lower table being supported above said base plate;
an upper table stacked above said lower table so as to move on and along said top surface;
a lower table actuating device connected to said lower table, said lower table actuating device moving said lower table in three of said six degrees of freedom; and
an upper table actuating device connected to said upper table, said upper table actuating device moving said upper table in the remain in the remaining three of said six degrees of freedom.

10. An object manufactured with the lithography system of claim 9.

11. A wafer on which an image has been formed by the lithography system of claim 9.

12. A method for making an object using a lithography process, wherein the lithography process utilizes a lithography system as recited in claim 9.

13. A method for patterning a wafer using a lithography process, wherein the lithography process utilizes a lithography system as recited in claim 9.
